(19) United States
(12) Patent Application Publication
(10) Pub. No.: US 2026/0264012 A1
(43) Pub. Date: Sep. 10, 2026

(54) ODOR REDUCING SYSTEMS FOR COMPOSTER ASSEMBLY

(71) Applicant: VCycene Inc., Markham (CA)

(72) Inventors: Huayi Gao, Markham (CA); Xiangdong Yin, King City (CA); Janusz Wielgosz, Toronto (CA); Ming Lam Timothy To, Scarborough (CA); Junaid Ahmed Siddiqui, Scarborough (CA)

(21) Appl. No.: 19/562,672

(22) Filed: Mar. 10, 2026

Related U.S. Application Data
(60) Provisional application No. 63/769,701, filed on Mar. 10, 2025.

(51) Int. Cl. B01D 53/86; B01D 53/00; B01D 53/04; B01D 53/88

(52) U.S. Cl. CPC B01D 53/8678; B01D 53/007; B01D 53/0454; B01D 53/8696; B01D 53/885; B01D 2253/102; B01D 2255/2073; B01D 2257/90; B01D 2258/05

(57) ABSTRACT

Various embodiments are described herein for an apparatus that implements one or methods for neutralizing odors produced within a composting apparatus. The system may include: a composting chamber configured to receive and decompose organic waste, thereby generating odors; a positive air pressure source configured to circulate air within the composting chamber; an odor destruction unit configured to neutralize odors and one or more air circulation pathways for directing air from the composting chamber to the odor destruction unit. The odor destruction unit comprises at least one of: an activated carbon filter, a manganese dioxide (MnO₂) catalyst, a photocatalytic oxidizer, a plasma generator, an ozone generator, a biofilter, or a UV-C sterilizer.

### CROSS REFERENCE TO RELATED APPLICATION

This application claims the benefit of U.S. Provisional Patent Application No. 63/769,701, filed Mar. 10, 2025, the entire contents of which are incorporated herein by reference.

### FIELD

The various embodiments described herein generally relate to filtration systems for composting assemblies; and more specifically to filtration systems for reducing odors produced within composting assemblies.

### BACKGROUND

The following paragraphs are provided by way of background to the present disclosure. They are not, however, an admission that anything discussed therein is prior art or part of the knowledge of persons skilled in the art.

Composting is the natural process of recycling organic matter, such as leaves and food scraps, into compost that can be used to enrich soil and plants. All organic discards decompose eventually however, composting can be used to speed up the process by providing an ideal environment for composting to occur. In simple composters, ideal humidity and temperature conditions can be maintained to complete the composting process. In some more complex composters, decomposing organisms (such as bacteria, fungi, worms, sowbugs, and/or nematodes) may be used to compost the organic matter. In other composters, chemicals may be used to compost the organic matter.

However, one of the major challenges associated with composting, particularly in enclosed composting systems, is the generation of unpleasant odors. These odors are primarily caused by the microbial breakdown of organic materials, which releases volatile organic compounds (VOCs), ammonia, hydrogen sulfide, and other malodorous gases. The intensity and type of odors produced depend on factors such as moisture levels, aeration, temperature, and the composition of the organic waste.

### SUMMARY OF VARIOUS EMBODIMENTS

In one aspect, in at least one embodiment described herein, there is provided an odor filtration system for a composting device. In at least one embodiment, the odor filtration system comprises: a composting chamber configured to receive and decompose organic waste; a positive air pressure source fluidly coupled to the composting chamber and configured to circulate air within the composting chamber; an odor destruction unit configured to neutralize odors; one or more air circulation pathways for directing air from the composting chamber to the odor destruction unit; a plurality of sensors configured to monitor internal conditions within the composting device and collect sensor data; and a control unit configured to adjust the operation of the positive air pressure source and the air circulation pathways based on the sensor data, such that odors generated in the composting chamber are directed to the odor destruction unit by the positive air pressure source.

In at least one embodiment, the plurality of sensors includes temperature sensors, air pressure sensors, humidity sensors, gas resistivity sensors such as metal-oxide semiconductor (MOS) gas sensors, graphene based sensors, weight sensors or any combination thereof.

In at least one embodiment, the positive air pressure source includes an axial fan, a centrifugal blower, a diaphragm pump, a rotary vane pump, a piezoelectric air pump, or any combination thereof.

In at least one embodiment, the odor destruction unit comprises an activated carbon filter, a manganese dioxide (MnO₂) catalyst, an aluminum oxide (Al₂O₃) catalyst or filter, a photocatalytic oxidizer, a plasma generator, an ozone generator, a biofilter, a UV-C sterilizer, an electrolysis module or any combination thereof.

In at least one embodiment, the odor destruction unit further comprises an activated carbon filter for adsorbing volatile organic compounds (VOCs).

In at least one embodiment, the odor destruction unit includes a plasma generator for generating reactive species to neutralize odors.

In at least one embodiment, the control unit is configured to improve the air circulation pathways by adjusting airflow control valves based on real-time temperature, pressure, and air quality data.

In at least one embodiment, the control unit is configured to operate the system to recirculate warm air within the composting chamber to maintain an internal temperature of approximately 35° C. for aerobic composting.

In at least one embodiment, the composting chamber and positive air pressure source form a first fluidly connected loop, and the odor destruction unit forms a second fluidly connected loop, fluidly connected in parallel with the first loop via a branch conduit.

In at least one embodiment, the odor filtration system can further comprise an external airflow system for the composting device.

In at least one embodiment, the odor filtration system can comprise: a fresh air inlet configured to allow external air to enter the composting device; a second positive air pressure source configured to generate airflow into the composting chamber through the fresh air inlet; one or more air circulation pathways for directing air through the composting chamber; an exit air outlet for expelling air from the composting device; and an exit air filter for cleaning air before it is expelled from the exit air outlet. In at least one embodiment, the control unit can be configured to activate the fresh air inlet and the positive air pressure source when the oxygen level in the composting chamber falls below a predetermined threshold, wherein the control unit is also configured to activate the exit air outlet when internal pressure exceeds a specified limit.

In at least one embodiment, the fresh air inlet further comprises an intake air filter configured to filter odors from the intake air.

In at least one embodiment, oxygen sensors can be positioned within the composting chamber and configured to measure oxygen levels.

In at least one embodiment, the system can further include an energy preservation mechanism configured to reduce the intake of external air to reduce the energy required to heat the composting chamber, while allowing recirculated air to maintain an internal temperature conducive to aerobic composting.

In at least one embodiment, the second positive air pressure source can include an axial fan, a centrifugal blower, a rotary vane pump, a scroll blower or any combination thereof.

In at least one embodiment, the system can further include at least one pressure sensor configured to measure internal air pressure within the composting chamber.

In at least one embodiment, the system can further include an exhaust sensor configured to provide sensor data including temperature data, air pressure data, relative humidity data, gas resistivity data or any combination thereof.

In at least one embodiment, the system can further include: an intake sensor to monitor intake air quality data; and using the intake air quality data as baseline for air quality monitoring inside the system.

In at least one embodiment, the control unit can be configured to recirculate air within the composting chamber when oxygen levels are above the threshold.

In at least one embodiment, the system can further include an odor destruction unit positioned within the air circulation pathways, wherein air expelled through the exit air outlet passes through the odor destruction unit to neutralize odors.

In at least one embodiment, the system can further include an exit air filter to prevent by-products from the odor destruction unit escaping through the exit air outlet.

In at least one embodiment, the fresh air inlet includes a valve or damper controlled by the control unit to regulate the flow of external air based on oxygen levels and internal pressure.

In at least one embodiment, the valve is a one-way valve to prevent odor leaks.

In at least one embodiment, the system further includes at least one temperature sensor configured to measure the temperature within the composting chamber, and the control unit is configured to adjust the airflow to maintain an optimal temperature for aerobic decomposition.

In another aspect, in at least one embodiment described herein, there is provided a method for filtering odor from a composting device using an odor filtration system. In at least one embodiment, the method comprises: receiving and decomposing organic waste within a composting chamber; fluidly coupling a positive air pressure source to the composting chamber; the positive air pressure source being configured to circulate air within the composting chamber; directing, using one or more air circulation pathways, air from the composting chamber to an odor destruction unit that is configured to neutralize odors; collecting sensor data, using a plurality of sensors, internal conditions within the composting device; and adjusting, using a control unit, the operation of the positive air pressure source and the air circulation pathways based on the collected sensor data, such that odors generated in the composting chamber are directed to the odor destruction unit by the positive air pressure source.

In at least one embodiment, the plurality of sensors includes temperature sensors, air pressure sensors, humidity sensors, gas resistivity sensors such as metal-oxide semiconductor (MOS) gas sensors, graphene-based sensors, weight sensors or any combination thereof.

In at least one embodiment, the positive air pressure source comprises an axial fan, a centrifugal blower, a diaphragm pump, a rotary vane pump, a piezoelectric air pump, or any combination thereof.

In at least one embodiment, the method includes providing the odor destruction unit with an activated carbon filter, a manganese dioxide (MnO₂) catalyst, an aluminum oxide (Al₂O₃) catalyst or filter, a photocatalytic oxidizer, a plasma generator, an ozone generator, a biofilter, a UV-C sterilizer, an electrolysis module or any combination thereof.

In at least one embodiment, the method can optionally include adsorbing volatile organic compounds (VOCs) using an activated carbon filter in the odor destruction unit.

In at least one embodiment, the method can optionally include generating reactive species to neutralize odors by a plasma generator.

In at least one embodiment, the method can optionally include optimizing, by the control unit, the air circulation pathways by adjusting airflow control valves based on real-time temperature, pressure, and air quality data.

In at least one embodiment, the method can optionally include recirculating warm air within the composting chamber to maintain an internal temperature of approximately 35° C. for aerobic composting.

In at least one embodiment, the composting chamber and positive air pressure source form a first fluidly connected loop, and the odor destruction unit forms a second fluidly connected loop, fluidly connected in parallel with the first loop via a branch conduit.

In at least one embodiment, the method can optionally include: allowing, via a fresh air inlet, external air to enter the composting device; generating airflow to direct the external air into the composting chamber through the fresh air inlet, by a second positive air pressure source; directing air through the composting chamber by one or more air circulation pathways; expelling the air from the composting device via an exit air outlet; cleaning the air from the composting chamber before it is expelled from the exit air outlet using an exit air filter; activating, by the control unit, the fresh air inlet and the second positive air pressure source when the oxygen level in the composting chamber falls below a predetermined threshold, and activating, by the control unit, the exit air outlet when internal pressure exceeds a specified limit.

In at least one embodiment, the method can optionally include filtering odors from the intake air using an intake air filter positioned in the fresh air inlet.

In at least one embodiment, the method can optionally include monitoring oxygen levels using oxygen sensors positioned within the composting chamber.

In at least one embodiment, the method can optionally include reducing the intake of external air to reduce the energy required to heat the composting chamber, while allowing recirculated air to maintain an internal temperature conducive to aerobic composting, using an energy preservation mechanism.

In at least one embodiment, the second positive air pressure source comprises an axial fan, a centrifugal blower, a rotary vane pump, a scroll blower or any combination thereof.

In at least one embodiment, the method can optionally include monitoring internal air pressure within the composting chamber using at least one pressure sensor.

In at least one embodiment, the method can optionally include obtaining, by an exhaust sensor, sensor data including temperature data, air pressure data, relative humidity data, gas resistivity data or any combination thereof.

In at least one embodiment, the method can optionally include running, using the gas resistivity data, at least one machine learning algorithm to determine the composition of the exhaust air to determine the odor level; and determining whether the filter needs to be replaced. In some embodiments, the control unit is configured to execute a trained regression or classification model using exhaust-stream sensor features (e.g., MOS resistance, temperature, humidity) to estimate an odor index or filter health score and to trigger a filter replacement notification when a threshold is exceeded.

In at least one embodiment, the method can optionally include monitoring intake air quality; and using the air intake quality as a baseline for air quality inside the system.

In at least one embodiment, the method can optionally include recirculating warm air within the composting chamber when oxygen levels are above the threshold; and reducing fresh air inlet.

In at least one embodiment, the method can optionally include positioning the odor destruction unit within the air circulation pathways, wherein air expelled through the exit air outlet passes through the odor destruction unit to neutralize odors.

In at least one embodiment, the method can optionally include filtering, by an exit air filter to prevent by-products from the odor destruction unit escaping through the exit air outlet.

In at least one embodiment, the fresh air inlet includes a valve or damper controlled by the control unit to regulate the flow of external air based on oxygen levels and internal pressure.

In at least one embodiment, the method can optionally include: monitoring the temperature within the composting chamber, and adjusting the airflow, using the control unit, to maintain an optimal temperature for aerobic decomposition.

Other features and advantages of the present application will become apparent from the following detailed description taken together with the accompanying drawings. It should be understood, however, that the detailed description and the specific examples, while indicating preferred embodiments of the application, are given by way of illustration only, since changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a block diagram of a composting apparatus showing an odor neutralization system, according to an example embodiment.

FIG. 2 is a block diagram of a composting apparatus showing an odor neutralization system, according to another example embodiment.

FIG. 3 is a left-side cross-sectional view of a composting apparatus, showing an odor neutralization system, according to an example embodiment.

FIG. 4 is a left-side cross-sectional view of a composting apparatus, showing the air filtration pathways, according to an example embodiment.

FIG. 5A is a block diagram showing an example of the airflow direction of the odor neutralization system.

FIG. 5B is a block diagram showing another example of the airflow within the odor neutralization system.

FIG. 6 is a rear cross-sectional view of a composting apparatus, showing an odor neutralization system, according to an example embodiment.

FIG. 7 is a front cross-sectional view of a composting apparatus, showing an odor neutralization system, according to an example embodiment.

FIG. 8 is a right-side view of a composting apparatus, according to an example embodiment.

FIG. 9 is a rear view of a composting apparatus, according to an example embodiment.

FIG. 10 a front-perspective view of a composting apparatus, according to an example embodiment.

FIG. 11 a rear-perspective view of a composting apparatus, according to an example embodiment.

Further aspects and features of the example embodiments described herein will appear from the following description taken together with the accompanying drawings.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject-matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled”, or “coupling” as used herein can have several different meanings depending in the context in which these terms are used. For example, the terms coupled, or coupling can have a mechanical, electrical or fluidic connotation. For example, as used herein, the terms coupled or coupling can indicate that two elements or devices can be directly connected to one another or connected to one another through one or more intermediate elements or devices via an electrical signal, electrical connection, fluidic pathway or a mechanical element depending on the particular context.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any operable combination thereof. Accordingly, the term “any combination thereof” is meant to cover any operable combination of the elements which precede the phrase. For example, the phrase “A, B, C, D or any combination thereof” includes A; B; C; D; A and B; A and C; A and D; B and C; B and D; C and D; A, B and C; A, B and D; A, C and D; B, C and D as well as A, B, C and D assuming that all such combinations are operable (i.e., they can be used together in practice in a working embodiment) otherwise inoperable options are not meant to be included.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect” “to, at least, provide,” “to, at least, transmit,” and so on.

A portion of the example embodiments of the systems, devices, or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and non-volatile memory). These devices may also have at least one input device (e.g., a keyboard, a mouse, a touchscreen, other input elements or any operable combination thereof) and at least one output device (e.g., a display screen, a printer, a wireless radio, other output elements or any operable combination thereof) depending on the type of device.

It should also be noted that there may be some elements that are used to implement at least part of the embodiments described herein that may be implemented via software that is written in a high-level procedural language such as object-oriented programming. The program code may be written in C, C⁺⁺ or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments described herein may be stored on a storage media or a device that is readable by a general or special purpose programmable device. The software program code, when read by the programmable device, configures the programmable device to operate in a new, specific and predefined manner in order to perform at least one of the methods described herein. For example, various embodiments herein have a control unit that is configured to perform one or more functions. It should be understood that the control unit has one or more processing/programmable devices that, when certain software programs are executed, become configured to function in specific ways in accordance with the teachings herein. The control unit may include at least one processor.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Accordingly, any device described herein that executes software instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

The various embodiments described herein generally relate to apparatuses and methods for composting food waste, as well as paper products, cardboard products, and some plastics. Composting is the natural process of recycling organic matter, such as garden waste, yard waste and food scraps, into compost that can be used to enrich soil and plants. All organic discards decompose eventually; however, composting can be used to speed up the process by providing an ideal environment for composting to occur.

One of the major challenges associated with composting, particularly in enclosed composting systems, is the generation of unpleasant odors. These odors are primarily caused by the microbial breakdown of organic materials, which releases volatile organic compounds (VOCs), ammonia, hydrogen sulfide, and other malodorous gases. The intensity and type of odors produced depend on factors such as moisture levels, aeration, temperature, and the composition of the organic waste.

To mitigate odors in composters, various techniques have been developed. One common approach is aeration, which involves introducing oxygen to promote aerobic decomposition. Proper aeration helps reduce the production of anaerobic byproducts, such as hydrogen sulfide, that contribute to strong, unpleasant smells. However, aeration requires continuous or periodic airflow, which may necessitate mechanical equipment such as fans or aeration pipes, leading to increased energy consumption and maintenance requirements. Additionally, excessive aeration can accelerate moisture loss, potentially drying out the composting material and disrupting microbial activity, thereby slowing the decomposition process. Moreover, aeration alone may not sufficiently neutralize all odorous compounds, particularly those that are inherently produced even under aerobic conditions.

Another method is the use of biofilters, which consist of organic materials such as wood chips, peat, or compost that act as a natural filtration system to absorb and neutralize odorous compounds. While biofilters can effectively capture and degrade certain odor-causing compounds, they require regular maintenance to prevent clogging and media degradation. The efficiency of biofilters is highly dependent on factors such as humidity, microbial colonization, and filter bed composition, making it challenging to maintain optimal performance over time. Additionally, biofilters may generate secondary waste in the form of spent filter media, which must be periodically replaced and disposed of properly.

Additionally, chemical treatments, including odor-neutralizing sprays and additives such as activated carbon or baking soda are sometimes used to capture or chemically alter odor-causing molecules. However, these treatments often provide only temporary relief and require repeated application, increasing operational costs. Activated carbon, while effective at adsorbing VOCs and other gases, has a limited adsorption capacity and must be replaced or regenerated once saturated. Similarly, baking soda and other alkaline additives can help neutralize acidic odors but may disrupt the composting process by altering pH levels, potentially affecting microbial activity and decomposition efficiency. Furthermore, some chemical sprays may introduce artificial fragrances that mask odors rather than eliminating them, leading to incomplete odor control.

Therefore, it is beneficial to have a composter in which odors produced are continuously destroyed. In most composting systems, odors can be produced from areas where composting occurs. For example, some of these odor-producing areas include areas where the decomposition of organic waste occurs, typically the composting chamber or crush chamber, which generates odors as food waste breaks down. The liquid collection chambers, if present in the composting device, can also be an area where unpleasant odors are produced.

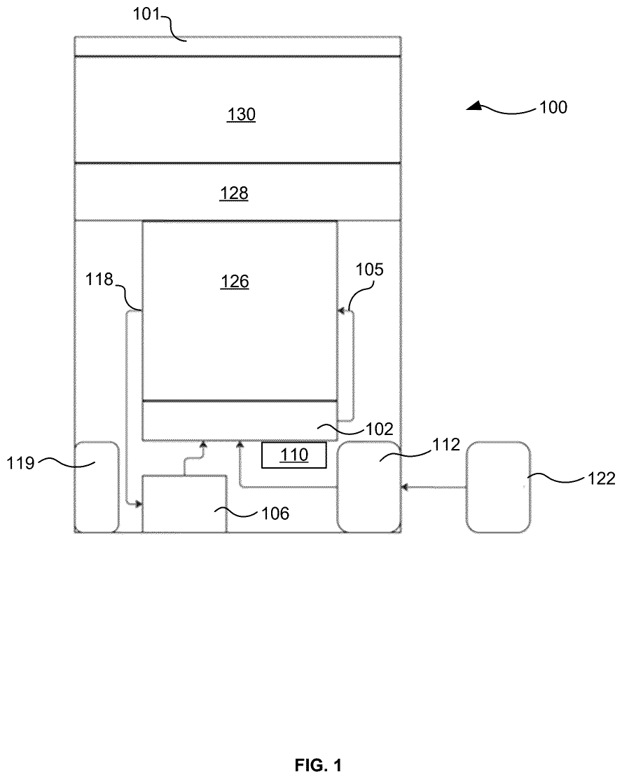

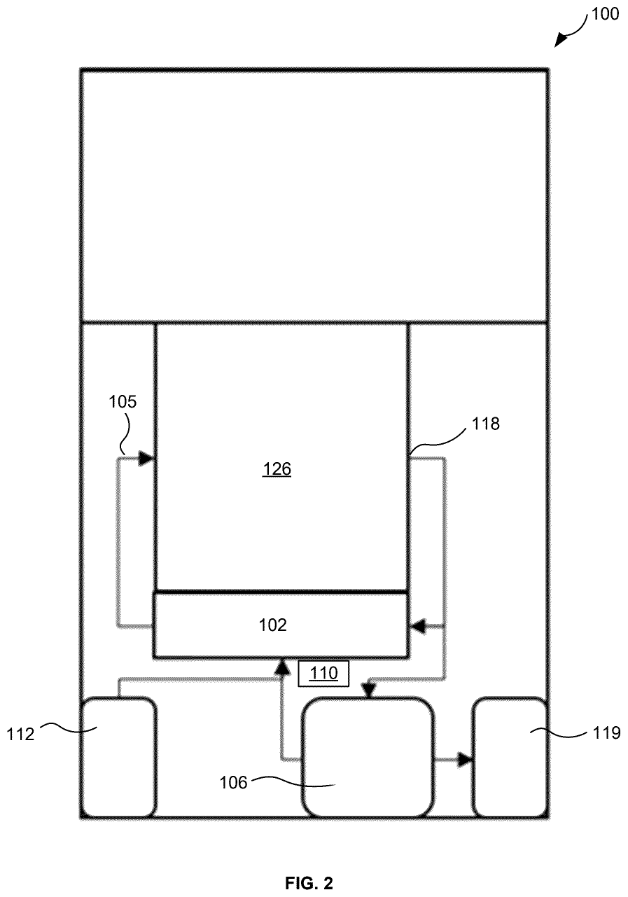

In order to effectively destroy odors produced in the composting device, an odor neutralization system can be provided within the composting device. In at least one embodiment, the odor filtration system can be comprised of two subsystems, namely an inner filtration system and an external airflow system. FIGS. 1 and 2 provide block diagrams of a composting apparatus 100 showing an odor filtration system, according to an example embodiment.

The inner filtration system of the composting device can be used to continuously neutralize odors generated during the composting process while maintaining optimal airflow and temperature conditions inside the device. On the other hand, the external airflow system can be used to maintain oxygen levels, preserve internal temperatures, and assist in odor control in the composting device. The inner filtration system and external airflow system can work synergistically together to create an optimal environment for aerobic composting and to ensure that odors are effectively eliminated.

In at least one embodiment, the inner filtration system includes a positive air pressure source 102, an odor source, an odor destruction unit 106 and a moveable lid 101. The positive air pressure source generates airflow that moves odors from sources like the compost chamber 126, crush chamber, or moisture collection tray and directs the odorous air towards the odor destruction unit 106. The positive air pressure source and odor destruction unit effectively neutralizes odors as they are produced, ensuring an odor-free experience for users in both indoor and outdoor environments. The lid 101 can be opened and closed to provide material to be composted to the composting apparatus 100.

In at least one embodiment, the inner filtration system can be located within a composting device. The composting device can include a composting chamber configured to receive and decompose organic waste, thereby generating odors. In at least another embodiment, the composting device can include a grey water tank which holds any discarded liquid collected during the composting process. The liquid tank may also be an odor source. The area where the decomposition of organic waste occurs, typically the composting chamber or crush chamber, which generates odors as food waste breaks down.

In at least one embodiment, the inner filtration system includes a positive air pressure source 102 configured to circulate air within the composting chamber 126. In at least one embodiment, the positive air pressure source can be a fan, blower, or other air-moving device, such as an axial fan or centrifugal blower, that maintains a controlled airflow within the inner filtration system. Alternative positive air pressure sources may include various types of air-moving devices, such as scroll blowers or piezoelectric pumps, depending on the size and configuration of the composting device. The positive air pressure sources create positive pressure inside the filtration pathways, ensuring that air flows consistently through the device's internal compartments. The positive air pressure source ensures that airflow moves continuously from the odor source (the composting chamber) to the odor destruction unit 106. This constant circulation prevents odor accumulation within the composting chamber. The positive air pressure generated from the positive air pressure source 102 ensures that odorous air is funneled directly from the odor source into air circulation pathways, ultimately reaching the odor destruction unit 106.

In at least one embodiment, the inner filtration system can include one or more air circulation pathways for directing air from the composting chamber 126 to the odor destruction unit 106. In at least one embodiment, the one or more air circulation pathways can include ducts or channels through which air is circulated within the compositing device. The pathways can be designed to optimize airflow over the composting chamber, capturing any odors generated during the composting process. The pathways can be engineered to distribute air evenly throughout the system, ensuring that all odors are directed towards the odor destruction unit. Odorous air from the composting chamber can therefore easily move toward the odor destruction unit 106, and then can either be recirculated or is expelled via the external airflow system, ensuring that no untreated odors are released from the device.

In at least one embodiment, the internal ducts or air channels may be modified to optimize airflow patterns based on the specific layout of the composting chamber, ensuring even air distribution and more efficient odor capture. In at least one embodiment, the airflow pathways can be constructed from durable, heat-resistant materials to withstand the warm, moist conditions inside the composting chamber. Adequate insulation and airtight seals can also be provided so that airflow remains controlled and that no odors escape unintentionally.

In at least one embodiment, the inner filtration system can include airflow control valves. In at least one embodiment, the airflow control valves are valves or dampers that regulate airflow within the system to ensure that only necessary air is passed through the odor destruction unit. The airflow control valves can help conserve energy and prolong the life of the filtration components. The airflow control valves can be controlled by a control unit, which adjusts them based on sensor readings for pressure, temperature, and air quality. In at least one embodiment, the control valves can be configured to direct airflow towards the odor destruction unit, and circulate the odorous air until the odors are destroyed.

The odor destruction unit 106 is responsible for neutralizing the odors. The odor destruction unit consists of various filtration and neutralization technologies, depending on the specific embodiment of the device. In at least one embodiment, the odor destruction unit can include at least one of: activated carbon filters, manganese dioxide filters, aluminum oxide filters, photocatalytic oxidizers, plasma generators, ozone generators, biofilters, electrolysis or UV-C sterilizers. Depending on user requirements, different odor destruction units may be used, such as a combination of activated carbon filters and plasma generators, or UV-C light integrated with photocatalytic oxidation.

Activated carbon filters operate by adsorbing odor-causing molecules onto a highly porous carbon structure. The activated carbon is processed to create an extensive internal surface area, which enhances its ability to capture and retain volatile organic compounds (VOCs) and other odorants through physical adsorption. As air passes through the filter, odor molecules become trapped within the micropores of the carbon material, effectively removing them from the airflow. The adsorption efficiency of activated carbon can be affected by factors such as pore size distribution, airflow rate, humidity, and the specific chemical properties of the odor molecules.

Manganese dioxide (MnO₂) filters operate by oxidizing odor compounds through chemical reactions that convert malodorous molecules into less odorous or non-volatile byproducts. MnO₂ is a highly effective oxidation catalyst, particularly for the breakdown of sulfur-based and nitrogen-based odorants such as hydrogen sulfide (H₂S) and ammonia (NH₃). When exposed to MnO₂, the odorous compounds undergo oxidation reactions, where electrons are transferred to the catalyst, leading to their decomposition into stable, non-odorous substances such as sulfur dioxide (SO₂) or nitrogen gas (N₂). The process typically occurs at ambient or elevated temperatures and does not require external energy input beyond the natural movement of air through the catalytic material.

Aluminum oxide (Al₂O₃) filters operate through oxidation reactions that break down odor-causing compounds into non-volatile byproducts. Al₂O₃ serves as both a support material and a reactive surface for catalytic oxidation, facilitating the conversion of VOCs, sulfur compounds, and nitrogen-based odorants into water (H₂O), carbon dioxide (CO₂), or other less odorous substances. The catalytic efficiency of Al₂O₃ is enhanced by its high surface area and thermal stability, allowing it to sustain oxidation reactions over extended periods. In some embodiments, Al₂O₃ can be impregnated with additional catalytic agents, such as transition metals, to improve oxidation performance and expand its effectiveness across a broader range of odor compounds.

Photocatalytic oxidizers use ultraviolet (UV) light to break down organic odor molecules through a process known as photocatalysis. Titanium dioxide (TiO₂) is commonly used as the photocatalyst, which, when exposed to UV light, generates highly reactive species. The reactive species can interact with VOCs and other odor molecules, initiating oxidation reactions that degrade the compounds into carbon dioxide and water.

Plasma generators produce reactive species that neutralize VOCs and other odorants through ionization processes. These systems generate a plasma field by applying high-voltage electrical energy to air or a gas mixture, leading to the formation of charged particles, free radicals, and excited molecules. The reactive species produced in the plasma interact with odor-causing compounds, breaking them down through oxidation, reduction, or molecular fragmentation. Plasma-based odor control can be effective for treating airborne contaminants in enclosed spaces, such as a composting device or system, as it can rapidly neutralize a wide range of VOCs, sulfur compounds, and other malodorous substances.

Ozone generators work by producing ozone (O₃), a highly reactive gas that breaks down odor molecules through oxidation reactions. Ozone is generated by passing oxygen (O₂) through a high-energy electrical field or ultraviolet light, causing the oxygen molecules to dissociate and recombine as ozone. When ozone interacts with VOCs, sulfur compounds, or nitrogen-based odorants, it facilitates their decomposition into non-odorous byproducts, such as CO₂ and H₂O.

Biofilters utilize microbial organisms to metabolize and neutralize odor molecules through biological degradation processes. These systems typically consist of a packed bed of organic media, such as compost, wood chips, or peat, which provides a habitat for odor-degrading bacteria and fungi. As odorous air passes through the biofilter, microorganisms consume the odorants as a metabolic substrate, converting them into carbon dioxide (CO₂), water (H₂O), and other non-odorous byproducts.

Electrolysis utilizes the separation of water (H₂O) molecules into hydrogen (H₂) and oxygen (O₂) gases to facilitate the breakdown of odor molecules. This process is achieved by applying an electrical current to an electrolyte solution, causing the dissociation of water at the anode and cathode. The reactive oxygen species generated during electrolysis can oxidize VOCs and other odorants, leading to their decomposition into less volatile and non-odorous compounds. Electrolysis-based odor control is particularly effective in liquid-phase and wastewater treatment applications, where dissolved odorants can be directly targeted. In at least one embodiment, Electrolysis-based odor control can be used for treating grey water tanks of composting devices.

UV-C sterilizers use ultraviolet (UV) light in the C-band spectrum (wavelengths ranging from approximately 200 to 280 nanometers) to break down odor-causing compounds and eliminate microbial sources of malodors. UV-C light is highly energetic and capable of disrupting molecular bonds in organic compounds, including volatile organic compounds (VOCs) and other odor-producing substances. When exposed to UV-C radiation, these compounds undergo photolytic degradation, breaking down into smaller, less volatile molecules that do not produce detectable odors.

In at least one embodiment, temperature and pressure sensors can be included within the composting device. The temperature, gas, and pressure sensors can be configured to monitor internal conditions within the composting device. Temperature, gas, and pressure sensors monitor the internal conditions within the composting chamber and airflow pathways. Temperature sensors ensure that the internal temperature is maintained at around 35° C., which is optimal for aerobic composting. The internal temperature can fluctuate +/−10 to 15° C. depending on a number of factors such as temperature of waste being input, external/ambient air temperature, etc. Pressure sensors can be used to detect the internal air pressure to ensure that the air moves consistently through the system without blockages or excessive pressure buildup. In at least one embodiment, pressure sensors: monitor internal air pressure to prevent over-pressurization, ensuring structural integrity and safety. Gas sensors can be used detect pollutants such as carbon dioxide (CO₂), nitrogen oxides (NOₓ), sulfur dioxide (SO₂), and volatile organic compounds (VOCs).

The sensors continuously monitor temperature, pressure, and air quality within the system. These sensors provide real-time data to a control unit 110, which adjusts the air pressure source and airflow control valves to maintain optimal conditions for odor destruction and composting.

In at least one embodiment, the inner filtration system can be fully automated and controlled by a microprocessor that processes data from the various sensors (temperature, pressure, and gas sensors). The inner filtration system further includes the control unit 110 configured to adjust the operation of the positive air pressure source and the air circulation pathways based on the sensor data, to ensure that odors generated in the composting chamber 126 are directed to the odor destruction unit 106, and recirculated air is either expelled or reintroduced into the composting chamber 126. The microprocessor may be included in the control unit 110. The control unit 110 can further include hardware that can be configured to implement the control logic that is used by the control unit 110. In at least one embodiment, the control unit 110 can include one or more processors/microprocessors configured to perform various functions when executing software code that embodies these functions, which can be one or more of the functions performed by the methods described herein. For example, if the pressure is greater than a threshold pressure, then increase positive air pressure and close airflow control valves. If the pressure is lower than a threshold pressure, then decrease positive air pressure and open airflow control valves. If the temperature is less than a threshold temperature, then recirculate warm air within the system. If the temperature is greater than a threshold temperature, then recirculate cool air within the system. In one embodiment, if the temperature is less than about 35° C. then recirculate warm air within the system. If the temperature is greater than about 35° C. then recirculate cool air within the system. If the odor levels are greater than a threshold level then increase air pressure and direct more air through the odor destruction unit.

The inner filtration system can work in tandem with the external airflow system, where fresh air is introduced only when necessary to maintain oxygen levels, while the inner system recirculates air to reduce energy consumption and control odors. When air needs to be expelled from the device (e.g., when pressure exceeds a certain threshold or fresh air inlet is required), the inner filtration system ensures that all exiting air has passed through the odor destruction unit, ensuring no odor leaks.

The external airflow system in the composting device enhances the efficiency of the composting process by managing oxygen levels, preserving internal temperatures, and assisting in odor control. The external airflow system can be used to direct air 122 through the inner filtration system, where odors are neutralized by the odor destruction unit before any air is expelled. The external airflow system creates an optimal environment within the composting chamber for aerobic composting.

The external airflow system is designed to enhance composting efficiency by maintaining optimal oxygen levels within the composting chamber. By ensuring a continuous supply of oxygen, the system supports aerobic microbial activity, which accelerates the decomposition process and improves overall composting performance.

The system also contributes to energy conservation by reducing/minimizing the introduction of cooler external air. By reducing the need to heat incoming air, the system helps preserve the internal temperature of the composting chamber, thereby reducing energy consumption and improving operational efficiency.

For odor management, the external airflow system ensures that any air expelled via the air exhaust 119 from the composting device undergoes treatment to neutralize unpleasant odors. This prevents unwanted smells from escaping into the surrounding environment, making the device more suitable for indoor use and maintaining a pleasant atmosphere in the user's home.

The system is further designed for safety and reliability, incorporating pressure regulation mechanisms to prevent over-pressurization within the composting chamber. By actively managing internal pressure levels, the system ensures safe and efficient operation while preventing potential structural or functional issues.

Additionally, the external airflow system enhances user convenience through automated controls that regulate airflow, oxygen levels, and pressure without requiring manual adjustments. This automation allows the device to operate seamlessly, reducing the need for user intervention and providing a more effortless and efficient composting experience.

In at least one embodiment, the external airflow system includes a fresh air inlet 112, which is configured to introduce external air into the composting device, and a positive air pressure source, which generates airflow into the composting chamber through the fresh air inlet.

In at least one embodiment, the fresh air inlet is an intake port equipped with a controllable valve or damper that allows fresh external air to enter the device when required. The fresh air inlet can prevent the ingress of contaminants or pests when not in operation.

In the embodiments described herein, the various mechanical and electrical components may be controlled by the control unit or another processing device.

In at least one embodiment, the positive air pressure source of the external airflow system can be a fan, blower, or other air-moving device, such as an axial fan or centrifugal blower, that maintains a controlled airflow within the inner filtration system. Alternative positive air pressure sources may include various types of air-moving devices, such as scroll blowers or piezoelectric air pumps, depending on the size and configuration of the composting device. In one embodiment, variable speed fans can be implemented to adjust airflow rates dynamically. The positive air pressure source can be controlled via a microprocessor to adjust airflow rates based on real-time sensor data.

One or more air circulation pathways can also be provided to direct airflow through the composting chamber, ensuring adequate aeration for the composting process. Air circulation pathways can include internal ducts or channels that guide the flow of air from the fresh air inlet through the composting chamber and into the inner filtration system. The air circulation pathways can be engineered to ensure even distribution of oxygen and maintain temperature consistency throughout the compost material. In at least one embodiment, the air circulation pathways can be designed with smooth surfaces to reduce resistance and improve airflow efficiency.

To regulate oxygen levels within the composting chamber, oxygen sensors can be positioned within the chamber and configured to monitor oxygen concentrations in real time, and continuously. The external airflow system further includes an exit air outlet, which is designed to expel air from the composting device when necessary. When oxygen levels drop below a predetermined threshold (e.g., 15% O₂ concentration), the sensors can trigger the system to introduce fresh air. An exit air filter may also be included. The exit air filter can prevent incompletely oxidized by-products from the odor destruction unit escaping though the exit air outlet. The exit air filter addition allows relocation of MnO₂, Al₂O₃, and active carbon from the odor destruction unit where odor volume load is high to the exit air filter where the odor volume load is significantly reduced.

The oxygen sensors continuously assess the oxygen concentration within the composting chamber. If oxygen levels fall below the optimal threshold (e.g., below 15% O₂), the control unit can activate the positive air pressure source and opens the fresh air inlet valve. Fresh air can then be drawn into the device, increasing the oxygen concentration to support aerobic microbial activity. Air circulation pathways can distribute the fresh air is evenly throughout the compost material. Once optimal oxygen levels are restored, the system closes the fresh air inlet and adjusts the positive air pressure source accordingly.

In another embodiment, advanced sensors can be integrated within the external airflow system. For example, humidity sensors can be used to monitor moisture levels and adjust airflow accordingly. In at least one embodiment, VOC (Volatile Organic Compounds) sensors can be used to detect odor levels more precisely.

The control unit 110 is configured to manage airflow within the external airflow system. When the oxygen level within the composting chamber 126 falls below a predetermined threshold, the control unit activates the fresh air inlet and the positive air pressure source to introduce additional oxygen. In at least one embodiment, the control unit 110 is configured to execute software for implementing algorithms including those used to balance oxygen levels, temperature, and energy efficiency. The algorithms can be stored in memory that is coupled to and readable by with the control unit 110.

The control unit 110 can be shared with the internal filtration system control unit 110. The control unit 110 can execute algorithms to take inputs from oxygen, temperature, and pressure sensors to make real-time decisions. For example, the control unit 110 can further be configured to, if oxygen levels are less than a threshold amount of oxygen levels, activate the fresh air inlet and the positive air pressure source. If pressure levels are greater than a threshold pressure, then the control unit 110 can be configured to open exit air outlet or activate exhaust fan.

Additionally, if the internal pressure within the composting chamber exceeds a specified limit, the control unit can be configured to activate an exit air outlet to release excess air, thereby preventing pressure buildup. In at least one embodiment, the exit air outlet is an exhaust port that allows air to exit the device when internal pressure exceeds a certain threshold or when excess air needs to be expelled. In one embodiment, the exit air outlet may include a one-way valve or an exhaust fan that activates under specific conditions.

In at least one embodiment, the system can include a pressure regulation process that may be executed by the control unit. The pressure regulation process includes the steps of: monitoring, activation, odor treatment, air release, and deactivation. During the monitoring step, pressure sensors detect the internal air pressure within the device. If the internal pressure exceeds a safe threshold, the control unit opens the exit air outlet or activates the exhaust fan, during the activation step. Before air is released, it passes through the odor destruction unit to ensure that no unpleasant odors are emitted. Excess air can then be expelled from the device, preventing over-pressurization (air release). Once pressure levels return to normal, the exit air outlet is closed, or the exhaust fan is deactivated.

The external airflow system can further include an energy preservation mechanism, which is designed to minimize the intake of external air to reduce the energy required to heat the composting chamber. By prioritizing the recirculation of treated air, the external airflow system maintains an internal temperature conducive to aerobic composting while improving overall energy efficiency.

In at least one embodiment, the energy preservation mechanism is designed to optimize thermal efficiency within the composting device by incorporating temperature maintenance, recirculation, insulation, and selective air exchange.

For temperature maintenance, the system limits the introduction of cooler external air, which typically enters at approximately 22° C. By reducing the need to heat incoming air to the optimal composting temperature of 35° C., the system decreases overall energy consumption while maintaining effective composting conditions. Recirculation of the air further enhances energy efficiency. When oxygen levels within the composting chamber are sufficient, warm internal air is redirected through the inner filtration system rather than being expelled. This approach minimizes heat loss while ensuring adequate aeration and odor control.

To retain heat within the composting chamber, the external airflow system incorporates thermal insulation materials that help prevent heat dissipation. The insulation ensures that the composting process remains thermally stable, reducing the frequency of external heating requirements.

Selective air exchange is implemented to balance oxygen supply with energy conservation. Fresh air is introduced only when necessary, such as when oxygen levels drop below a predetermined threshold. By controlling the frequency and volume of air intake, the system maintains aerobic composting conditions while minimizing heat loss and energy expenditure.

The external airflow system and inner filtration system are designed to operate in an interconnected manner, with the external system supplying fresh air as needed and the inner system managing odor neutralization and air recirculation. This coordinated operation ensures optimal composting conditions while maintaining energy efficiency and effective odor control.

During air intake, the external airflow system introduces fresh air into the composting chamber when triggered by the control unit 110. The introduction of fresh air is regulated to maintain proper oxygen levels while minimizing unnecessary heat loss.

During circulation, the incoming air moves through the composting chamber, supplying oxygen to support aerobic microbial activity. The circulation process enhances the efficiency of organic matter decomposition by sustaining the microbial environment required for composting.

During odor neutralization, air carrying odor-causing compounds is directed toward the inner filtration system. Within this system, the air undergoes treatment through various filtration and chemical processes to neutralize odors before being recirculated or expelled.

During air exhaust, the treated air is either recirculated within the system to conserve energy and maintain internal temperature or expelled through an exhaust outlet 119 if necessary. The exhaust process ensures that the internal environment remains optimal for composting while preventing odor leakage into the surrounding space.

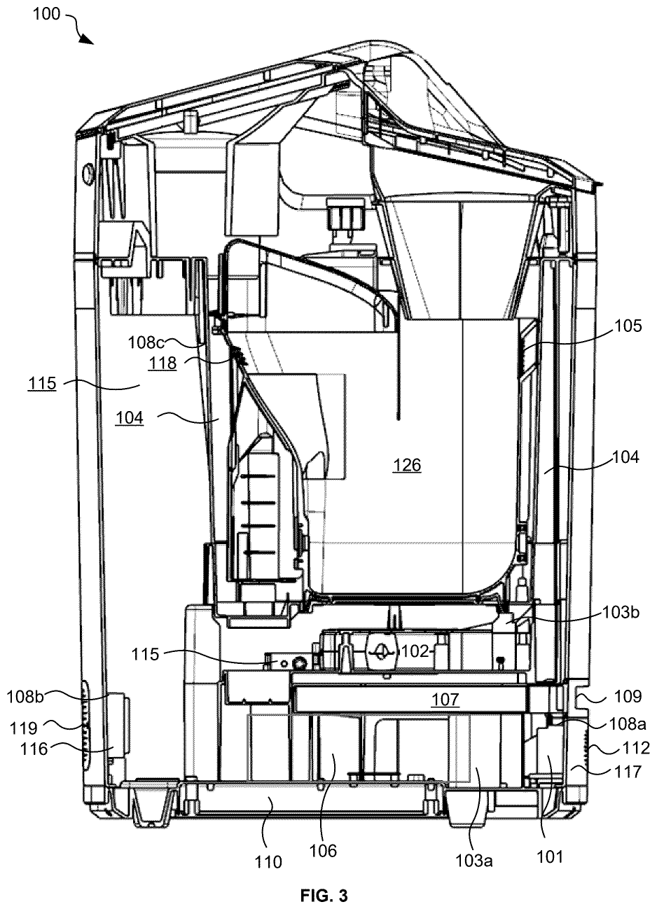

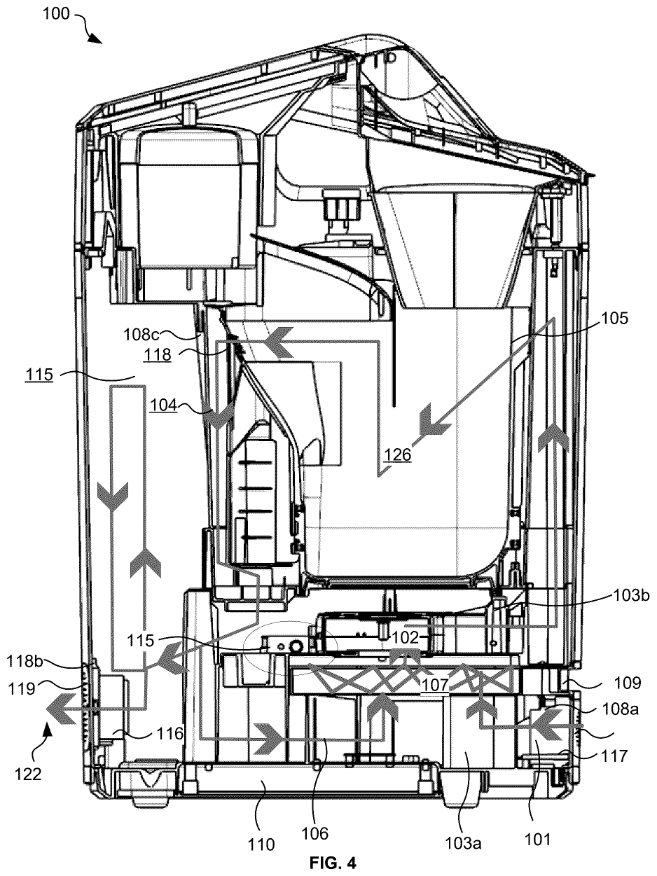

In at least one embodiment, a multistage pathway for odor destruction is provided, as shown in FIGS. 3 and 4. The odorous air generated in hybrid aerobic/anaerobic composting systems can be directed through a multi-stage destruction pathway to neutralize the diverse odor profiles.

At 402, external fresh air is inlet from the inlet 112 which comprises an inlet fan to allow external air to enter the chamber. In at least one embodiment, the fresh air can then be heated by primary heater 103a. The heated air makes contact with the filters, and is pulled upstream by the positive air pressure source 102. The air can be optionally heated once again by a secondary heater 103b. The hot air can then be pushed downstream and be transported by air circulation pathways 104, and into the composting chamber 126.

The hot air can then mix with the odors present in the odor source (such as the compost chamber) to form the odorous air. From the odor source (e.g., composting chamber), in at least one embodiment, the odorous air can optionally first pass through a mechanical pre-filtration stage comprising a mesh filter or cyclone separator. This stage removes particulate matter such as dust and debris, preventing clogging of downstream modules.

Next, the odorous air enters a low-temperature plasma generator 115. The plasma generator is strategically positioned to break down complex organic compounds (e.g., skatole, putrescine) and sulfur-based molecules (e.g., H₂S, mercaptans) into smaller intermediates. Reactive oxygen species (ROS) can be generated by the plasma oxidize volatile organic compounds (VOCs) while minimizing ozone production to avoid downstream interference.

The fragmented molecules can then flow into a photocatalytic oxidizer 106 equipped with UV-C lights and a titanium dioxide (TiO₂) catalyst. Here, aldehydes, alcohols, and volatile fatty acids (VFAs) are further degraded into carbon dioxide and water. The oxidizer employs a serpentine airflow design to maximize UV exposure and catalytic surface contact.

Subsequently, air passes through a catalyst bed 107. In at least one embodiment, the catalyst bed can be a manganese dioxide (MnO₂) catalyst bed, which targets residual sulfur compounds and ammonia. Optionally, activated carbon and MnO₂/Al₂O₃ can be mixed with specific ratios to maximize space efficiency. The MnO₂ bed converts hydrogen sulfide (H₂S) into elemental sulfur and oxidizes NH₃ into nitrogen and water. By placing this stage after plasma and photocatalytic units, sulfur compounds are pre-processed, enhancing catalyst efficiency.

The air then enters an activated carbon filter 107 with hybrid carbon-MnO₂ pellets. This stage adsorbs non-reactive gases (e.g., methane) and residual VOCs, leveraging the MnO₂ component to oxidize adsorbed compounds, thereby mitigating carbon saturation. A filter access port 107A can be placed on the outer body of the composting device, and give access to the filter so that the filter can be easily maintained or replaced. In at least one embodiment, the user can pull on the filter access port 107a, which has a recessed finger pull or recessed handle, to pull out the filter “drawer” for replacement or refill of filter material.

Optionally, a biofilter populated with odor-degrading microbes is positioned downstream to metabolize biodegradable residues (e.g., amines, organic acids). To protect microbial colonies, the biofilter is isolated from ozone-producing stages.

Finally, treated air is either recirculated to maintain internal temperature or expelled through an exhaust port. Recirculated air re-enters the composting chamber via the positive air pressure source, completing the closed-loop system. Optionally, air can exit the system via the exhaust 119. In at least one embodiment, exhaust filters can be placed before the exhaust to further filter the exhaust before it exits the system.

To resolve conflicts between modules (e.g., plasma-generated ozone degrading activated carbon), a staged oxidation-adsorption sequence can be optionally performed. In the oxidation-adsorption sequence, plasma and photocatalytic stages are prioritized upstream to decompose recalcitrant odors, while MnO₂ and carbon stages handle residual byproducts. The use of low-temperature plasma minimizes ozone generation, and any residual ozone is neutralized by the MnO₂ bed before reaching the carbon filter.

For compact systems, a hybrid carbon-MnO₂ filter can be used as it can combine adsorption and oxidation in a single unit. The compact design reduces footprint while addressing saturation by enabling continuous oxidation of adsorbed compounds.

In at least one embodiment, the internal filtration system integrates a smart recirculation loop controlled by sensors monitoring VOC levels, temperature, and pressure. The sensors can also be used to monitor oxygen levels to ensure certain oxygen levels are maintained to maximize aerobic process and minimize anaerobic odor generation. When odor thresholds are exceeded, airflow rates are reduced below 100 CFM to extend residence time in destruction modules. Warm recirculated air minimizes energy required to heat incoming fresh air, maintaining optimal composting temperatures (35° C.). Recirculation further reduces external air heating demands while ensuring aerobic conditions.

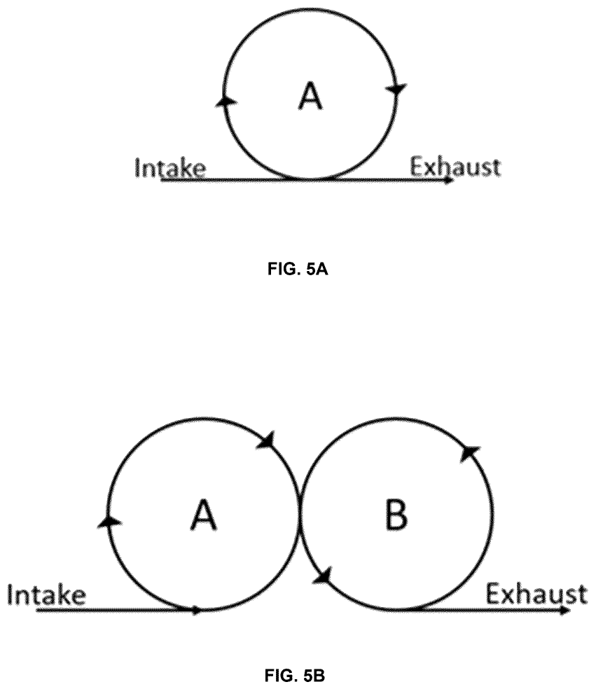

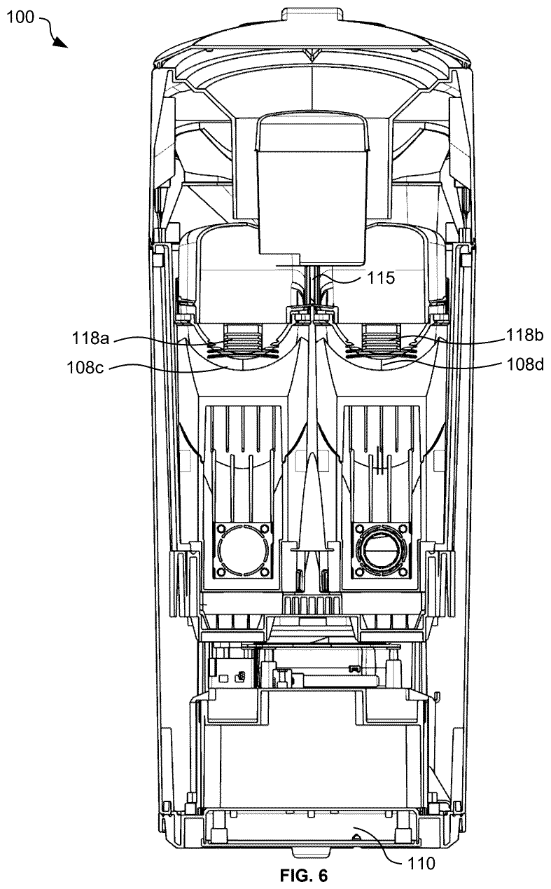

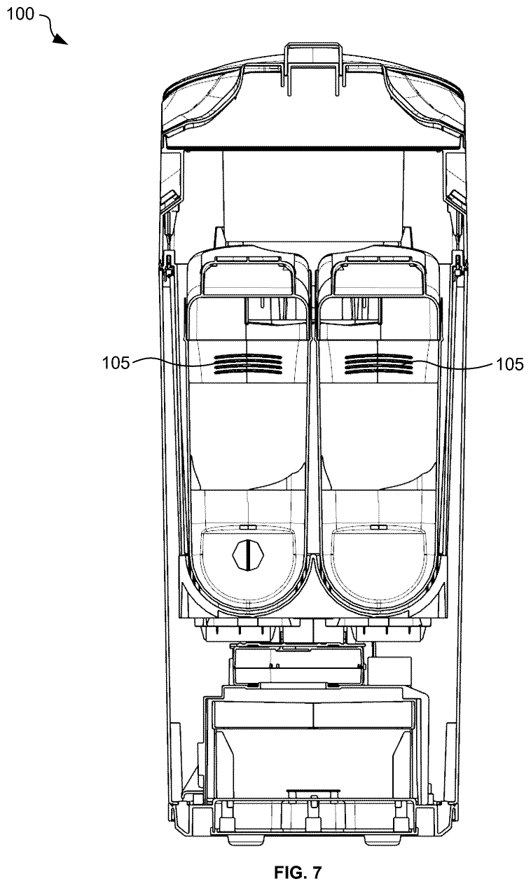

FIG. 5A provides a block diagram that shows the air flow direction in a system that has the compost chambers and the odor destruction assembly in series. In this embodiment, the intake and exhaust are connected directly to the circulation assembly. FIG. 5B provides a block diagram of the airflow in a parallel system. In this embodiment, cycle A is the composting/odor generation and cycle B is the odor destruction assembly. In this embodiment, cycle A and cycle B operate in parallel. The air intake is connected directly to composting assembly, and the odor destruction assembly precedes the exhaust path so the odor must pass through the odor destruction assembly.

The following table provides common odors in composting and destruction options using the odor destruction unit.

| | Moisture Level | Odor Compounds | Chemical Formula | Odor Destruction Solutions |
|---|---|---|---|---|
| Aerobic | Dry | Ammonia | NH₃ | Activated carbon filters (adsorption) |
| | | Amines | CH₃NH₂, C₂H₅NH₂ | MnO₂ catalysts (oxidation) |
| | | | | Biofilters (microbial breakdown) |
| | Wet | Volatile Fatty Acids | CH₃COOH | Photocatalytic oxidizers (TiO₂ + UV-C) |
| | | (VFAs) | (acetic acid), C₃H₆O₂ | |
| | | Alcohols | C₂H₅OH (ethanol) | Plasma generators (reactive species |
| | | | | breakdown) |
| | | Aldehydes | HCHO (formaldehyde) | Ozone generators (oxidation) |
| Anaerobic | Dry | Hydrogen Sulfide | H₂S | MnO₂ catalysts (converts H₂S to S⁰) |
| | | Mercaptans (thiols) | CH₃SH | Plasma generators (breaks S—H bonds) |
| | | | (methyl mercaptan) | |
| | | Ammonia | NH₃ | Activated carbon filters (adsorption) |
| | Wet | Methane | CH₄ | Catalytic oxidizers (converts |
| | | | | CH₄ to CO₂ + H₂O) |
| | | Putrescine/Cadaverine | C₄H₁₂N₂, C₅H₁₄N₂ | Biofilters (microbial degradation) |
| | | Organic Acids (e.g., butyric | C₄H₈O₂ | Photocatalytic oxidizers |
| | | acid) | | (UV-C + TiO₂) |
| | | Skatole | C₉H₉N | Activated carbon + plasma hybrid |
| | | | | systems (adsorption + oxidation) |

In at least one embodiment, activated carbon filters can be utilized for odor control by adsorbing odor-causing compounds within a porous carbon structure. The large surface area of the activated carbon enables the capture and retention of gaseous molecules, including ammonia (NH₃), amines, and sulfur-containing compounds. By adsorbing these volatile compounds, the system can effectively reduce odors before the air is recirculated or expelled.

In at least one embodiment, manganese dioxide (MnO₂) catalysts can be employed to facilitate the oxidation of odor-causing compounds, converting them into non-odorous byproducts. These catalysts may be used to oxidize hydrogen sulfide (H₂S), mercaptans, and volatile fatty acids (VFAs), thereby reducing the presence of malodorous gases within the system.

In at least one embodiment, plasma generators can be incorporated to generate reactive oxygen species (ROS) that break down complex organic odor compounds. This process can be particularly effective for decomposing persistent organic molecules, such as skatole and aldehydes, into simpler, non-odorous byproducts.

In at least one embodiment, photocatalytic oxidizers can be implemented, utilizing a titanium dioxide (TiO₂) catalyst activated by UV-C light to provide a photocatalytic reaction that can be used to degrade odor-causing organic compounds. This photocatalytic reaction may be used to break down alcohols, aldehydes, and VFAs, converting them into carbon dioxide and water.

In at least one embodiment, biofilters can be integrated into the system to leverage microbial metabolism for odor reduction. The biofilter may contain microbial colonies that actively break down amines, putrescine, and organic acids, converting them into less harmful or harmless byproducts.

In at least one embodiment, ozone generators are utilized to produce ozone (O₃), which acts as a strong oxidizing agent to react with and neutralize various odor-causing compounds. Ozone oxidation may be employed to eliminate aldehydes and alcohols, breaking them down into non-odorous substances. In some embodiments, the use of ozone may be managed to prevent residual O₃ accumulation, thereby ensuring safe operation.

In at least one embodiment, for addressing aerobic odors, photocatalytic oxidizers and biofilters may be prioritized to neutralize volatile fatty acids (VFAs) and alcohol-based odor compounds. The photocatalytic oxidizers may utilize a titanium dioxide (TiO₂) catalyst activated by UV-C light to break down VFAs and alcohols into non-odorous byproducts, while biofilters may employ microbial colonies that metabolize these organic compounds, thereby reducing odor emissions.

In at least one embodiment, for controlling anaerobic odors, manganese dioxide (MnO₂) catalysts and plasma generators may be employed to target sulfur-based odor compounds, including hydrogen sulfide (H₂S) and mercaptans. The MnO₂ catalysts may function by oxidizing these compounds into non-odorous byproducts, whereas the plasma generators may generate reactive oxygen species (ROS) to break down persistent sulfur-based organics, ensuring effective odor mitigation. As such, both aerobic (e.g., NH₃, VFAs) and anaerobic (e.g., H₂S, skatole) odors are targeted through sequential oxidation and adsorption.

In at least one embodiment, hybrid odor control systems may be implemented by combining activated carbon filters with plasma generators or MnO₂ catalysts to address recalcitrant odors such as skatole. The activated carbon filters may first adsorb volatile compounds, while the plasma or MnO₂ stages may further oxidize and neutralize any residual odor molecules, enhancing the overall efficiency of odor removal. The separation of the reactive stages (plasma, MnO₂) from adsorption (carbon) can prevent interference and prolong material lifetime.

In at least one embodiment, thermal oxidation methods may be excluded from the system design to preserve energy efficiency. By avoiding high-temperature oxidation processes, the system may reduce energy consumption while maintaining effective odor neutralization through alternative filtration, catalytic, or biological treatment mechanisms.

Moisture generated during composting can compromise odor destruction modules by saturating filters, deactivating catalysts, or causing corrosion. It is therefore beneficial to provide methods and systems for reducing moisture in the composting device, and to establish a multi-tiered defense system against composting humidity fluctuations.

In at least one embodiment, a pre-filtration dehumidification system is provided. During composting, moisture-laden air first passes through the pre-filtration dehumidification system comprising a condensation coil and a desiccant wheel. The condensation coil can be coated with a hydrophobic nanomaterial (e.g., polytetrafluoroethylene) to minimize water adhesion, while the desiccant wheel utilizes a hybrid silica gel-molecular sieve structure for efficient moisture absorption and regeneration. Downstream, the airflow enters hydrophobically modified filters and catalyst units: activated carbon filters are silanized to form a water-repellent barrier while maintaining >90% porosity, and MnO₂ catalyst particles are encapsulated in fluoropolymer microcapsules to permit gas permeation while blocking liquid water. The pre-filtration dehumidification system can reduce humidity-induced efficiency loss and extend filter lifespan. The pre-filtration dehumidification system therefore achieves intrinsic moisture resistance with minimal energy overhead.

In at least one embodiment, a thermodynamic humidity control and corrosion-resistant airflow system is provided. To address condensation and metal corrosion, the Humidity Control and anti-corrosion system integrates a dynamic temperature-controlled airflow network. In at least one embodiment, the airflow pathway ducts are constructed from 316 stainless steel, coated internally with a silver-ion antibacterial layer (>99% microbial inhibition), and angled at about 1° to about 10°, and preferably about 2° to direct condensate toward automated drain valves. PTC ceramic heating elements (5 W/section) are embedded along the airflow path, regulated by a PID algorithm to maintain duct temperatures in the range of about 3 to about 15° C. above the dew point. When the control unit 110 determines that humidity sensors detect relative humidity are greater than about 40% to about 65%, the control unit 110 can then activate heating and reduces fan speed to about 50% to about 80% of its rated capacity, aligning airflow velocity with thermal gradients to eliminate condensation. This design limits residual moisture in ducts to less than about 0.1 mL/m³ to about 0.5 m/m³ and reduces metal corrosion rates compared to unprotected systems. The humidity control and anti-corrosion system can help eliminate condensation risks and extends hardware durability.

In at least one embodiment, a humidity-adaptive plasma-photocatalytic module is provided. In at least one embodiment, the integrated plasma-photocatalytic module can employ pulsed DC plasma technology and localized microenvironment control. A thermoelectric cooler (TEC) can be used within the plasma chamber to create a dry microzone (humidity less than about 30% to 40%) via the Peltier effect, while TiO₂-coated aluminum honeycomb electrodes serve dual roles as catalysts and hydrophobic surfaces. The photocatalytic reactor has baffled airflow channels to extend residence time to around 1 to 5 seconds, with UV-C lamps (254 nm wavelength) protected by hydrophobic quartz coatings to prevent light scattering. The integrated plasma-photocatalytic module can maintain greater than about 75% to 95% odor removal efficiency (VOC degradation ≥85%) even at approximately 60% to 80% ambient humidity. The integrated plasma-photocatalytic module ensures high-efficiency plasma-photocatalytic performance in humid conditions.

In at least one embodiment, a dynamic humidity balancing module for biofilters is provided. In at least one embodiment, the biofilter module adopts a layered humidity gradient design. In at least one embodiment, the upper layer uses hydrophobically modified coconut fiber substrate (30-40% moisture content), while the lower layer incorporates porous ceramic drainage and a humidity-responsive ventilation system. When the control unit 110 determines that substrate moisture sensors detect about >45% water content, the control unit activates a bottom-mounted blower to boost airflow velocity to about 1.5 m/s, evaporating excess moisture via forced convection. A vacuum-assisted siphon drains accumulated water to an external reservoir. Microbial colonies (e.g., Pseudomonas putida MTCC 2467) thrive at about 60-80% humidity, achieving 95 mg NH₃/(L·h) ammonia oxidation efficiency. Therefore, biofilter moisture fluctuations can be reduced to ±5%, preventing anaerobic zone formation.

In at least one embodiment, an intelligent humidity coordination system is provided. The humidity coordination system comprises a multi-node humidity sensor network (±2% RH accuracy) and adaptive algorithms enable system-wide humidity optimization. In at least one embodiment, the control unit 110 may be configured to operate according to a three-tiered response: primary regulation, secondary regulation and emergency mode. When the relative humidity (RH) is around 60-70% RH, the control unit 110 can maintain the system in primary regulation, which activates duct heating to maintain 35-38° C. When the relative humidity is around 70-80% RH, the control unit 110 can configure the system to enter secondary regulation which triggers desiccant wheel regeneration (about 70° C. to 100° C. hot air purge) and reduces compost chamber ventilation.

Finally, if the relative humidity is about 70% to 80% or higher, the control unit 110 can configure the system to enter emergency mode. In emergency mode, the control unit 110 sends out control signals to close fresh air inlets, and switch to full recirculation, as well as activates alarms. In at least one embodiment, data is transmitted via LoRa wireless modules to user interfaces, enabling remote humidity threshold adjustments and drainage control. This system reduces inter-module humidity variance to <8% and cuts energy consumption by about 20% to 40% compared to conventional dehumidification. The intelligent humidity coordination system optimizes system-wide humidity stability and energy efficiency.

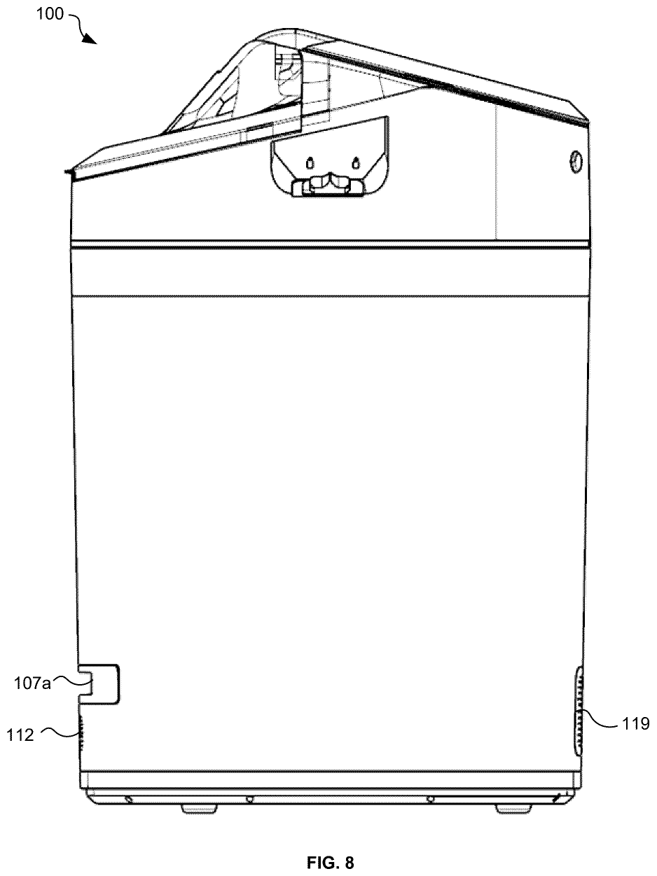

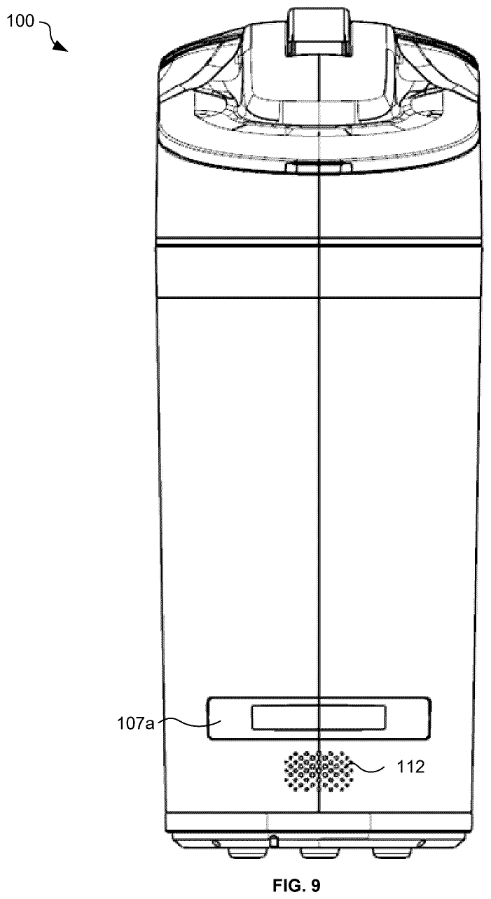

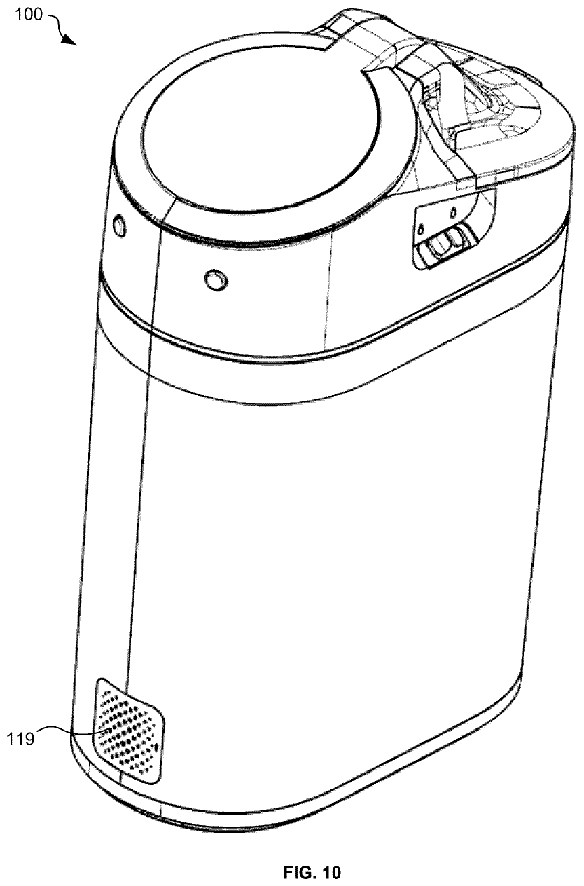

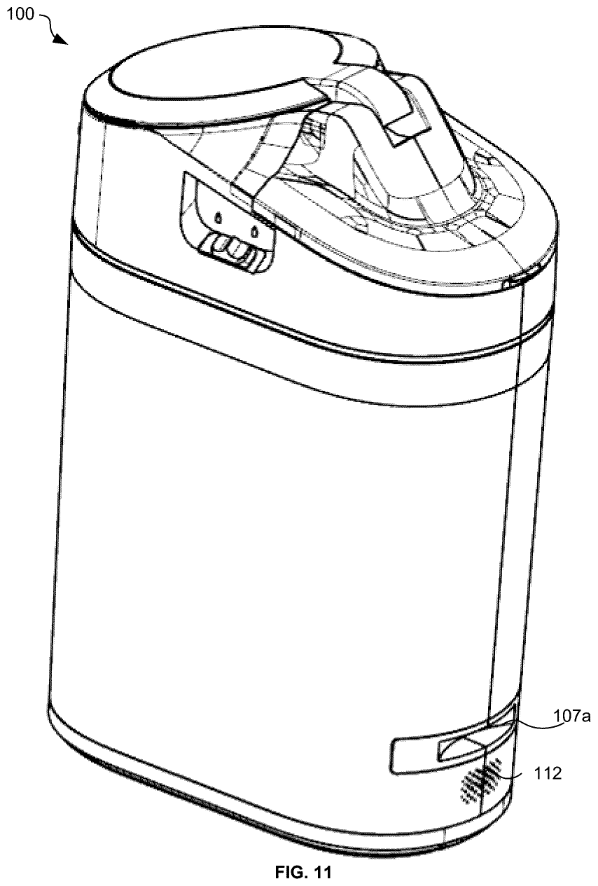

FIGS. 8 to 11 provide various views of the composting apparatus, according to an example embodiment.

In at least one embodiment, a method for neutralizing odors produced within a composting device is disclosed. The method comprises the steps of air capture, filtration, clean air recirculation, odor prevention, and continuous air circulation.

During air capture, as odorous compounds are generated within the composting or crushing chamber, air circulation pathways direct the air carrying odor molecules toward an odor destruction unit. This ensures that odorous air is promptly removed from the chamber and processed to mitigate undesirable emissions.

During filtration, the odorous air, upon reaching the odor destruction unit, passes through one or more filtration or reaction stages designed to neutralize odor compounds. Depending on the specific odor treatment technology employed, odor molecules may be adsorbed onto a filtration medium, chemically oxidized, or decomposed into non-volatile byproducts through catalytic or photolytic processes.

During clean air recirculation, the treated air, having been neutralized within the odor destruction unit, may either be recirculated within the composting device to conserve energy and maintain optimal operating temperature or expelled through an external airflow system when required. The expulsion of air through the external system may also be referred to as an exhaust phase.

During odor prevention, additional measures may be implemented to minimize odor generation. These measures may include introducing odor-neutralizing additives or controlling the composition of food waste or organic matter introduced into the composting chamber to regulate the type and intensity of odors produced during decomposition.

During continuous air circulation, a positive pressure source continuously drives airflow through the system, ensuring that odorous air is promptly captured and directed toward the odor destruction unit. The airflow rate may be actively managed through airflow control valves, which regulate the movement of air to maintain optimal pressure and temperature conditions within the composting chamber.

By recirculating warm air (maintained at about 25° C. to 45° C., preferably around 35° C.), the inner filtration system minimizes the need for fresh air inlet, which is typically cooler (around 15° C. to 25° C., preferably around 22° C.). This recirculation helps conserve energy by reducing the amount of air that needs to be heated, ensuring that the composting process remains efficient without excessive energy consumption.

In at least one embodiment, fresh air is only introduced into the system when oxygen levels fall below a certain threshold, as controlled by the external airflow system. This reduces the overall energy required to maintain composting conditions while preserving odor control.

In at least one embodiment, the inner filtration system provides odor control by capturing and treating odorous air generated within the composting chamber. By directing airflow through a dedicated filtration pathway, the system prevents unpleasant smells from escaping the device.

In at least one embodiment, the system is energy efficient, utilizing recirculated warm air to maintain optimal composting conditions while reducing overall energy consumption. By preserving heat within the system, the device minimizes the energy required to warm incoming fresh air, ensuring that the composting chamber remains at a temperature of approximately about 25° C. to 45° C., preferably around 35° C. without excessive power usage.

In at least one embodiment, the inner filtration system operates in coordination with external airflow control mechanisms, allowing fresh air to be introduced only when necessary. This reduces unnecessary air exchanges, optimizes ventilation, and conserves energy while maintaining aeration for the composting process.

In at least one embodiment, the system can function automatically with minimal user intervention. A positive air pressure source, in conjunction with sensors and airflow control valves, continuously regulates airflow to ensure optimal performance. This automation simplifies operation, allowing users to maintain an odor-free composting process without the need for manual adjustments.

In at least one embodiment, the inner filtration system can be a smart system, enabling integration with smart home systems. Through a companion app, users can remotely monitor system performance, adjust settings, and receive real-time updates on filtration status and operational conditions.

In at least one embodiment, the system includes an automatic shutdown feature that activates in response to unsafe conditions, such as excessive internal pressure or temperature fluctuations. Upon detecting such anomalies, the system can be halted to prevent potential damage or malfunction.

In at least one embodiment, the system can provide user notifications, and generate and deliver alerts through the device's interface or a connected app. These notifications inform users of any issues related to the inner filtration system, ensuring timely maintenance and continued optimal performance.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. An odor filtration system for a composting device, comprising:
a composting chamber configured to receive and decompose organic waste;
a positive air pressure source fluidly coupled to the composting chamber and configured to circulate air within the composting chamber;
an odor destruction unit configured to neutralize odors;
one or more air circulation pathways for directing air from the composting chamber to the odor destruction unit;
a plurality of sensors configured to monitor internal conditions within the composting device and collect sensor data; and
a control unit configured to adjust the operation of the positive air pressure source to adjust airflow through the air circulation pathways based on the sensor data, such that odors generated in the composting chamber are directed to the odor destruction unit by the positive air pressure source.

2. The odor filtration system of claim 1, wherein the plurality of sensors includes temperature sensors, air pressure sensors, humidity sensors, gas resistivity sensors such as metal-oxide semiconductor (MOS) gas sensors, graphene based sensors, weight sensors or any combination thereof.

3. The odor filtration system of claim 1, wherein the positive air pressure source comprises an axial fan, a centrifugal blower, a diaphragm pump, a rotary vane pump, a piezoelectric air pump, or any combination thereof.

4. The odor filtration system of claim 1, wherein the odor destruction unit comprises: an activated carbon filter, a manganese dioxide (MnO₂) catalyst, an aluminum oxide (Al₂O₃) catalyst or filter, a photocatalytic oxidizer, a plasma generator, an ozone generator, a biofilter, a UV-C sterilizer, an electrolysis module or any combination thereof.

5. The odor filtration system of claim 1, wherein the control unit is configured to improve the air circulation pathways by adjusting airflow control valves based on real-time temperature, pressure, and air quality data.

6. The odor filtration system of claim 1, wherein the control unit is configured to operate the system to recirculate warm air within the composting chamber to maintain an internal temperature of approximately 35° C. for aerobic composting.

7. The odor filtration system of claim 6, wherein the composting chamber and positive air pressure source form a first fluidly connected loop, and the odor destruction unit forms a second fluidly connected loop, fluidly connected in parallel with the first loop via a branch conduit.

8. The odor filtration system of claim 1, further comprising:
an external airflow system for the composting device, comprising:
a fresh air inlet configured to allow external air to enter the composting device;
a second positive air pressure source configured to generate airflow into the composting chamber through the fresh air inlet;
one or more air circulation pathways for directing air through the composting chamber;
an exit air outlet for expelling air from the composting device; and
an exit air filter for cleaning air before it is expelled from the exit air outlet;
wherein, the control unit configured to activate the fresh air inlet and the positive air pressure source when the oxygen level in the composting chamber falls below a predetermined threshold, wherein the control unit is also configured to activate the exit air outlet when internal pressure exceeds a specified limit.

9. The odor filtration system of claim 8, further comprising: an energy preservation mechanism configured to reduce the intake of external air to reduce the energy required to heat the composting chamber, while allowing recirculated air to maintain an internal temperature conducive to aerobic composting.

10. The odor filtration system of claim 8, wherein the second positive air pressure source comprises an axial fan, a centrifugal blower, a rotary vane pump, a scroll blower or any combination thereof.

11. The odor filtration system of claim 8, further comprising an exhaust sensor configured to measure sensor data including temperature data, air pressure data, relative humidity data, gas resistivity data or any combination thereof.

12. The odor filtration system of claim 8, wherein the odor destruction unit is positioned within the air circulation pathways, wherein air expelled through the exit air outlet passes through the odor destruction unit to neutralize odors.

13. A method for filtering odor from a composting device using an odor filtration system, the method comprising:
receiving and decomposing organic waste within a composting chamber;
fluidly coupling a positive air pressure source to the composting chamber, the positive air pressure source being configured to circulate air within the composting chamber;
directing, using one or more air circulation pathways, the air from the composting chamber to an odor destruction unit that is configured to neutralize odors;
collecting sensor data, using a plurality of sensors, internal conditions within the composting device; and
adjusting, using a control unit, the operation of the positive air pressure source and the air circulation pathways based on the collected sensor data, such that odors generated in the composting chamber are directed to the odor destruction unit by the positive air pressure source.

14. The method of claim 13, wherein the plurality of sensors includes temperature sensors, air pressure sensors, humidity sensors, gas resistivity sensors such as metal-oxide semiconductor (MOS) gas sensors, graphene based sensors, weight sensors or any combination thereof.

15. The method of claim 13, wherein the positive air pressure source comprises an axial fan, a centrifugal blower, a diaphragm pump, a rotary vane pump, a piezoelectric air pump or any combination thereof.

16. The method of claim 13, wherein the odor destruction unit comprises an activated carbon filter, a manganese dioxide (MnO₂) catalyst, a photocatalytic oxidizer, a plasma generator, an ozone generator, a biofilter, an UV-C sterilizer or any combination thereof.

17. The method of claim 13, further comprising:
allowing, via a fresh air inlet, external air to enter the composting device;
generating airflow to direct the external air into the composting chamber through the fresh air inlet, by a second positive air pressure source;
directing air through the composting chamber by one or more air circulation pathways;
expelling the air from the composting device via an exit air outlet;
cleaning the air from the composting chamber before it is expelled from the exit air outlet using an exit air filter;
activating, by the control unit, the fresh air inlet and the second positive air pressure source when the oxygen level in the composting chamber falls below a predetermined threshold, and
activating, by the control unit, the exit air outlet when internal pressure exceeds a specified limit.

18. The method of claim 13, further comprising: reducing intake of external air to reduce the energy required to heat the composting chamber, while allowing recirculated air to maintain an internal temperature conducive to aerobic composting, using an energy preservation mechanism.

19. The method of claim 13, further comprising: obtaining, by an exhaust sensor, sensor data including temperature data, air pressure data, relative humidity data, gas resistivity data or any combination thereof.

20. The method of claim 13, further comprising: running, using the gas resistivity data, at least one machine learning algorithm to determine the composition of the exhaust air to determine the odor level; and determining whether the filter needs to be replaced.
